(19) United States
(12) Patent Application Publication
(10) Pub. No.: US 2018/0264698 A1
(43) Pub. Date: Sep. 20, 2018

(54) APPARATUS FOR INJECTION MOULDING OF PLASTIC MATERIALS

(71) Applicant: INGLASS S.p.A., San Polo di Piave (TV) (IT)

(72) Inventors: Maurizio BAZZO, San Polo di Piave (TV) (IT); Nico TREVISIOL, San Polo di Piave (TV) (IT)

(21) Appl. No.: 15/745,590

(22) PCT Filed: Oct. 14, 2016
(86) PCT No.: PCT/IB2016/056168

§ 371 Date: Jan. 17, 2018

(30) Foreign Application Priority Data
Dec. 10, 2015 (IT) 102015000081904

(51) Int. Cl. B29C 45/28

(52) U.S. Cl. CPC B29C 45/281; B29C 2045/2824

(57) ABSTRACT

Apparatus for injection moulding of plastic materials including a mould including a distributor of the plastic material to be injected, at least one injector including a nozzle with respect to which a valve pin is moveable, and a respective electric actuator for controlling displacement of the valve pin between a closing position and an opening position. The electric actuator is connected to a supply and control unit fixed to the mould and univocally associated thereto.

### FIELD OF THE INVENTION

The present invention refers to apparatus for injection moulding of plastic materials including a mould comprising a distributor of plastic material to be injected, at least one injector including a nozzle with respect to which a valve pin is moveable, and actuator means for controlling the displacement of the valve pin between a closing position and an opening position to enable the flowing of the pressurised fluid plastic material from the distributor to the mould cavity.

### STATE OF THE PRIOR ART

Conventionally, actuator means for controlling the valve pin of the or of each injector consist in fluid actuators which entail sensitive complications due to the need of providing dedicated systems and pipings for supplying oil or air, as well as almost zero control options except for an ON/OFF actuation. In addition, there are problems related to cleaning, and overall dimensions due to the presence of the pipings.

Actuation systems employing electric motors, in particular of the rotary type, and provided with devices for detecting the position of the valve pin, for example an encoder or resolver associated to the shaft of the rotary motor and connected to a stand-alone electronic unit through which a prompt and precise control of the position, speed and acceleration of the valve pin is carried out, alongside the monitoring and recording data in real time, were proposed with the aim of overcoming these drawbacks. The electronic unit is usually provided separately with respect to the mould and it is designed to be indistinctly combined with any mould provided with electric actuators, regardless of the number thereof. However, the undeniable advantages in terms of flexibility and precision in controlling the moulding process have a negative impact on the supply and operating costs of the equipment and the overall dimensions of the work area, considering that the unit should necessarily always remain connected to the system during operation. Examples regarding this are described and illustrated for example in the published

European patent applications EP-2679374A1, EP-2918389A1 and EP-3009251A1, all on behalf of the Applicant of the present patent. In the concrete application of the solutions described in these documents, whose costs are high and considerably higher than those of fluid actuators, rotary electric motors are of the brushless type provided with an encoder or resolver and combined with a stand-alone electronic unit.

### SUMMARY OF THE INVENTION

The object of the present invention is to provide a simpler, more cost-effective and less cumbersome alternative to the prior art systems with the aforementioned electric motors, while maintaining the undeniable advantages with respect to systems with fluid actuators in terms of construction simplicity of the apparatus, cleaning and possibility of adjusting the main opening and closing parameters of the single injector (e.g. position, speed, acceleration).

According to the invention, this object is attained thanks to an injection moulding apparatus of the type defined above, whose distinctive characteristic lies in the fact that the supply and control unit is fixed to the mould and univocally associated thereto.

The supply and control unit is preferably secured to the fixing plate of the mould. The electric supply is provided by means of connectors located on the unit, while the control of the main parameters for opening and closing of the injectors occurs by suitably configuring the driver of the circuit board associated to each electric motor and positioned in the unit.

This solution idea enables at least partly obtaining the advantages of the electric motors provided for in the aforementioned prior art solutions, but eliminating the use of the stand-alone electronic control unit, thus cutting costs considerably and reducing the the overall dimension of the working area.

Preferably, the electric motor is of the rotary brushless type and provided with an encoder or resolver.

Alternatively, the electric motor is of the direct current and rotary type, or, according to a less advantageous variant, it can be of the asynchronous or universal type.

The configuration of the main parameters for opening and closing the single injectors is simplified and occurs by manually setting the driver of each electronic control board arranged inside the unit. The configuration control is carried out by the operator preferably for example through a universal external control panel (e.g. a PLC), i.e. usable for configuring the drivers of any unit according to the invention. Alternatively, the control can be carried out through potentiometers associated to the circuit board, for example accessible through a special opening obtained in the supply and control unit, or even by means of dedicated push buttons or a control unit directly arranged on the supply unit. According to a further variant, the configuration controls may be carried out from remote, for example directly on the control panel of the injection machine.

According to a preferred embodiment of the invention, upon configuring the drivers of the circuit boards regarding each electric motor, the opening and closing control of each injector can be directly sent by the control panel of the injection machine or, alternatively, by a general sequential control unit already owned by the customer.

The moulding apparatus which uses the electric motors may be variously configured, in that they can be alternatively carried by the fixing plate of the mould or by the machine platen or by the distributor.

### BRIEF DESCRIPTION OF THE DRAWINGS

The invention will now be described in detail, purely by way of non-limiting example, with reference to the attached drawings, wherein:

FIG. 1 is a schematic front view of the mould fixing plate of an injection moulding apparatus according to an embodiment of the invention in which there are provided three injection points,

FIG. 2 is a dorsal view of the fixing plate of FIG. 1,

FIG. 3 shows the groups of the three injection points of the fixing plates of FIGS. 1 and 2,

FIG. 4 is a cross-sectional view of the entire moulding apparatus at one of the injection points and specifically the central one with reference to FIGS. 1 to 3,

FIG. 5 shows an enlarged scale of a part of FIG. 4,

FIG. 6 is an elevational schematic view and in larger scale of one of the motor-transmission units of the injection points of the apparatus,

FIG. 7 is a sectional view of FIG. 6.

FIG. 8 is a lateral view of FIG. 6,

FIG. 9 is a perspective view of the unit represented in FIGS. 6 to 8,

FIG. 10 is an elevational schematic view according to arrow X of FIG. 1, and

FIG. 11 is a lateral view according to arrow XI of FIG. 10.

### DETAILED DESCRIPTION OF THE INVENTION

The described embodiment refers—for the sake of simplicity—to an injection moulding apparatus provided with electric motors with configuration control of the driver of the circuit board that each motor is provided with, for example by means of potentiometers or other equivalent systems to be addressed hereinafter.

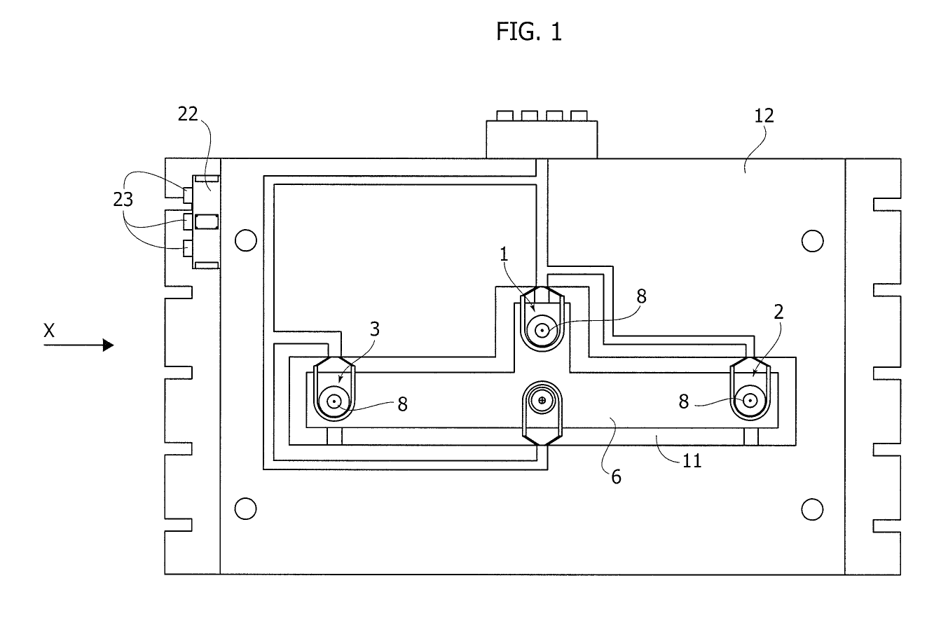

The apparatus is provided with three injection points generally indicated with 1, 2 and 3 in FIG. 1 and whose configuration substantially corresponds, save for the distinctive difference to be mentioned hereinafter, to those described and illustrated in the previously mentioned patent documents EP-2679374A1 and EP-2918389A1.

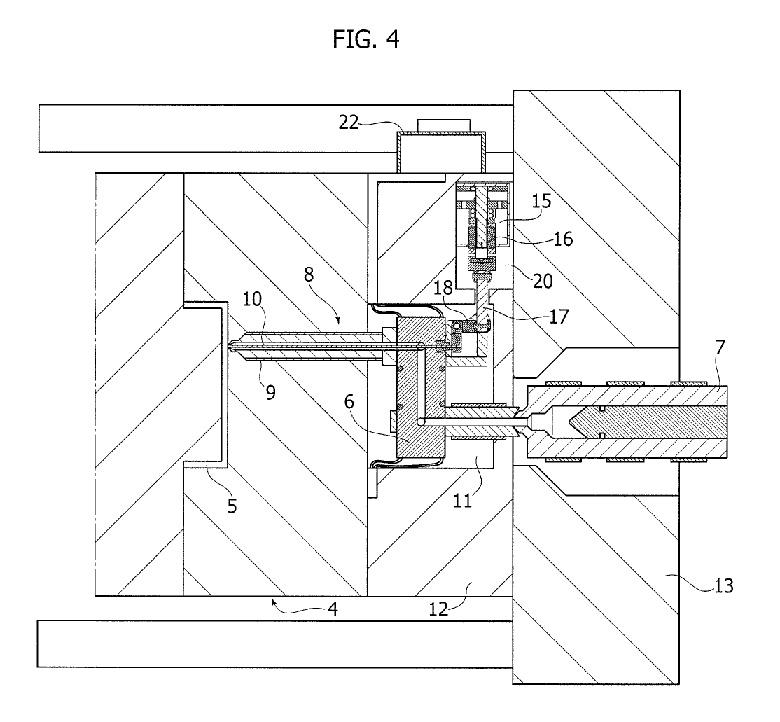

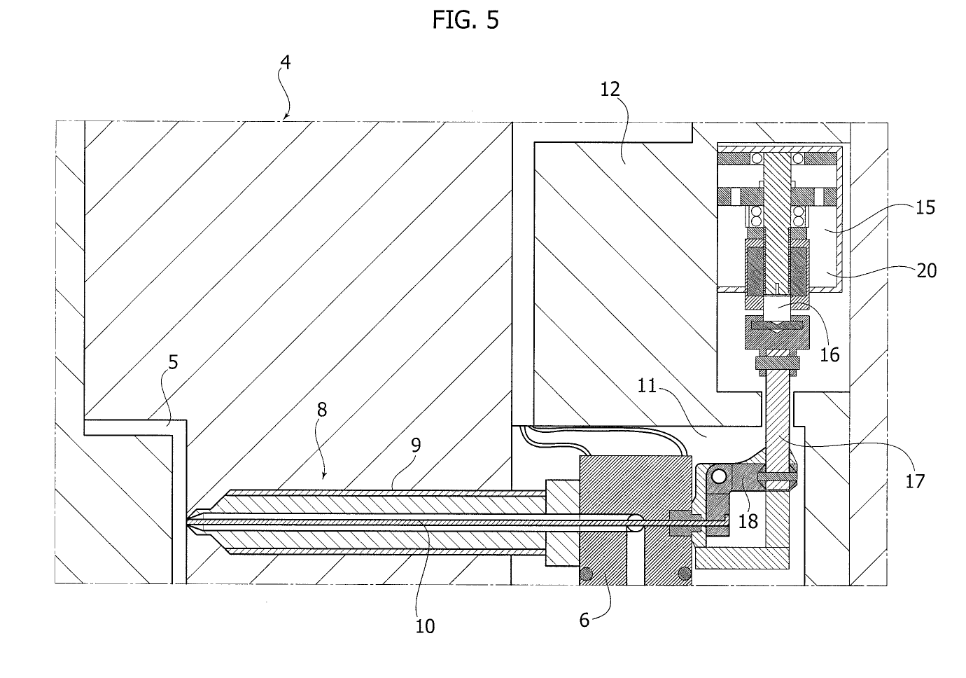

The central injection point 1 is shown in detail in FIGS. 4 and 5, in which there is represented a schematic section of the fundamental components of the injection apparatus: a mould 4, delimiting a moulding cavity 5, comprising a distributor or hot chamber 6 which receives the plastic material in fluid state from the nozzle of an injection machine 7, and an injector 8 carried by the distributor 6 and including a tubular nozzle 9 in which a valve pin 10 can be axially displaced between advanced an closing position and a receded opening position to enable the flowing of the fluid plastic material from the distributor 6 to the cavity 5 of the mould 4.

In the case of the illustrated example the distributor 6 is housed in a cavity 11 of a fixing plate or clamping plate 12 configured, possibly combined with further plates, for fixing the mould 4 to a machine platen 13 of the moulding apparatus.

The cavity 11 of the fixing plate 12 within which the distributor 6 is housed, is faced towards the moulding cavity 5.

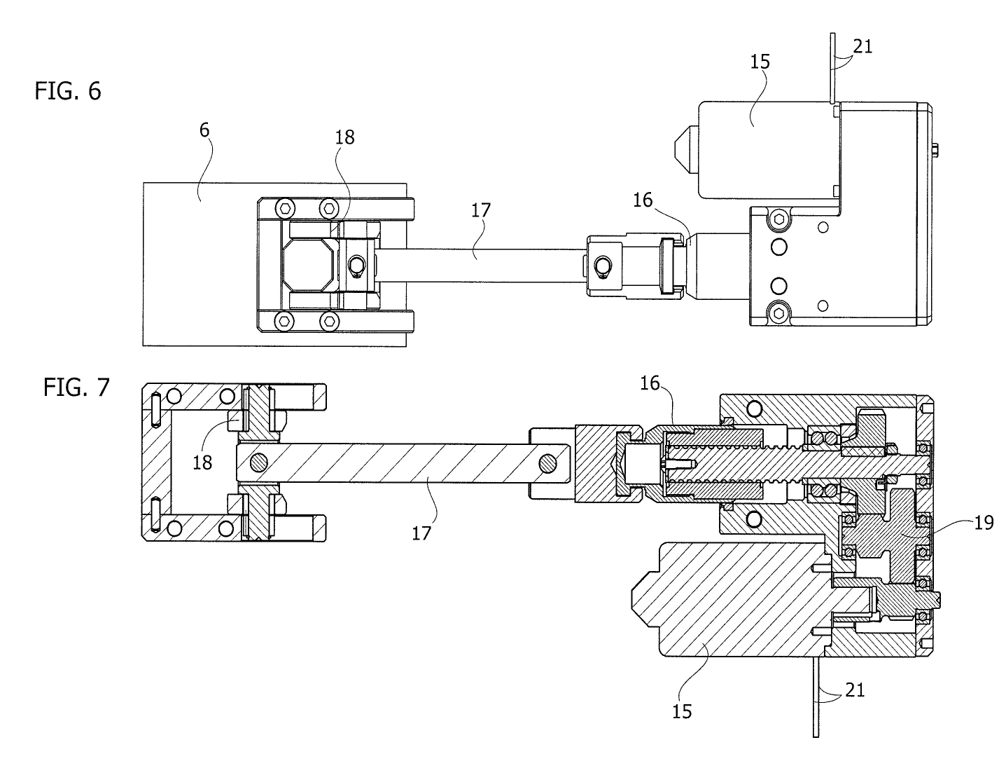

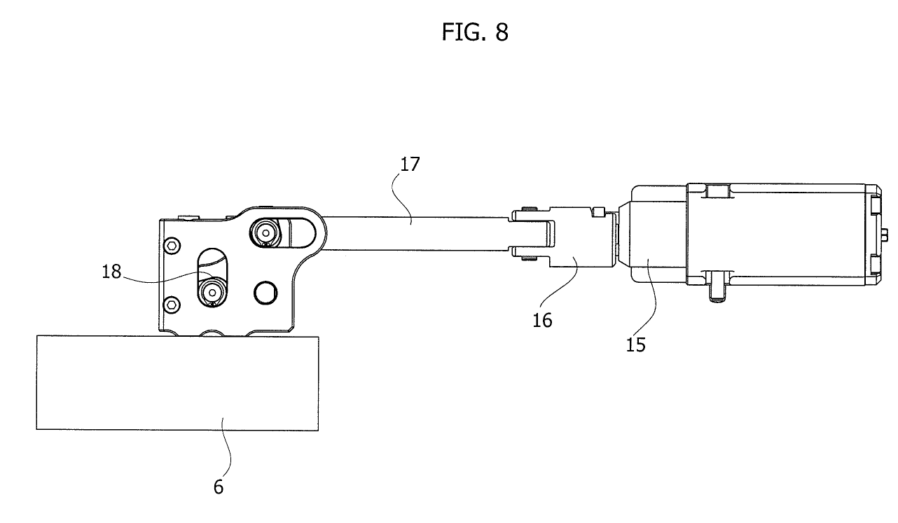

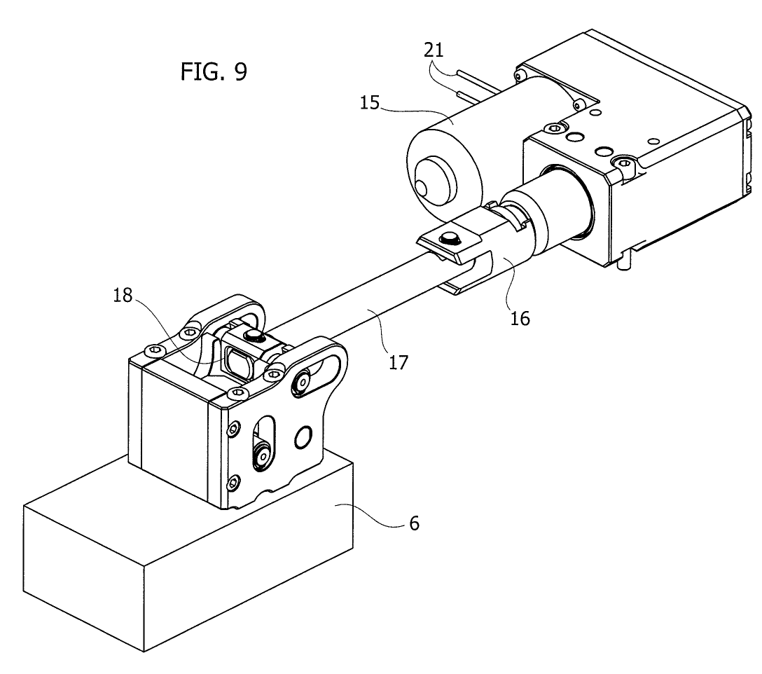

The valve pin 10 of the injector 8 is actuated by a pre-assembled actuator unit illustrated in detail in FIGS. 6 to 9 and comprising, also in a manner generally known from the previously mentioned prior art patent documents, a rotary electric motor 15 whose shaft drives, through a gear multiplier 19, a nut and screw unit 16 which in turn actuates, through a variable length transmission rod 17, an oscillating lever 18 carried by the distributor 6. As better observable in FIGS. 4 and 5 the oscillating lever 18 controls the translation of the valve pin 10 between the positions for closing and opening the injector 8.

According to a preferred embodiment, the rotary motor 15 is a brushless electric motor provided with an encoder or resolver. Alternatively, the rotary motor could be of the direct current, asynchronous or universal type.

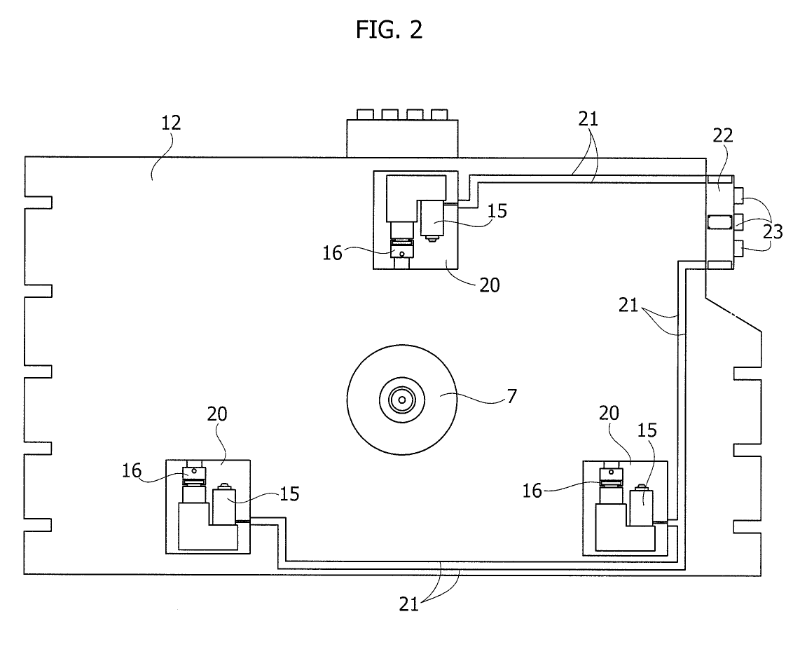

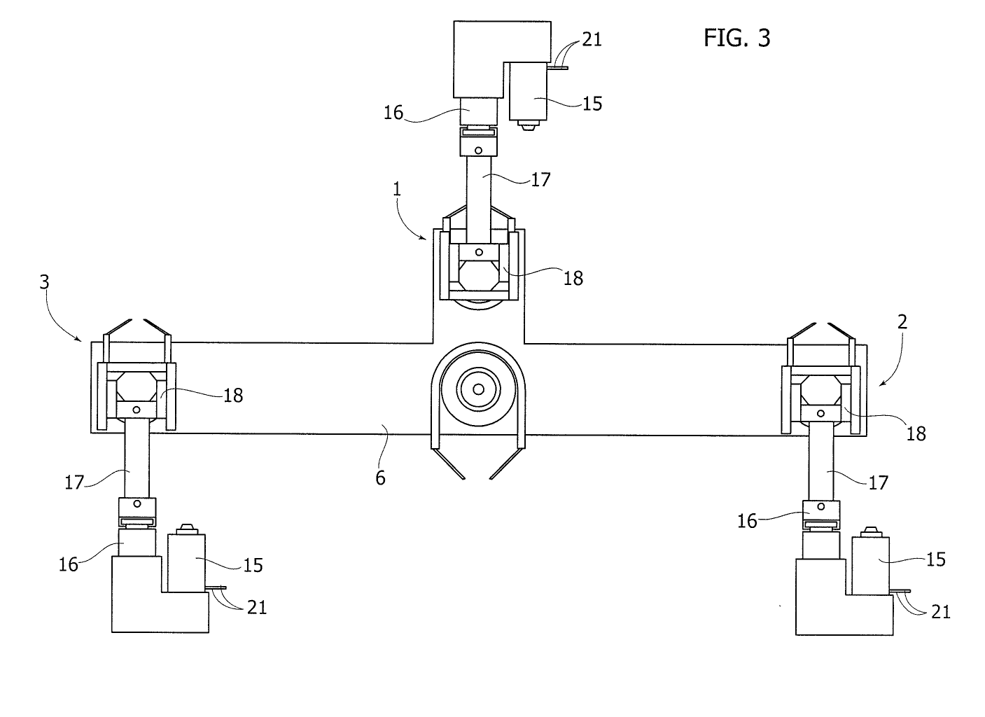

Now back to FIGS. 1 and 2, in the case of the illustrated embodiment the actuator unit described above (electric motor 15 and the relative transmission 16 and 17) is housed in a respective seat 20 formed on the face of the fixing plate 12 opposite to the moulding cavity 5.

According to the distinctive characteristic of the invention each rotary electric motor 15 is housed, through respective supply and control conductors 21 extending on the same face of the fixing plate 12, to a supply and control unit 22 preferably applied to such fixing plate 12 or to one of the plates that form the mould 4. Alternatively, the unit 22 may be fixed to the distributor 6 indirectly, i.e. on the support structure of the cables of the distributor 6, as previously known as concerns solenoid valves for controlling fluid actuators (see for example FIG. 1 of the Chinese patent application CN-104943065A on behalf of Guandong Yudo).

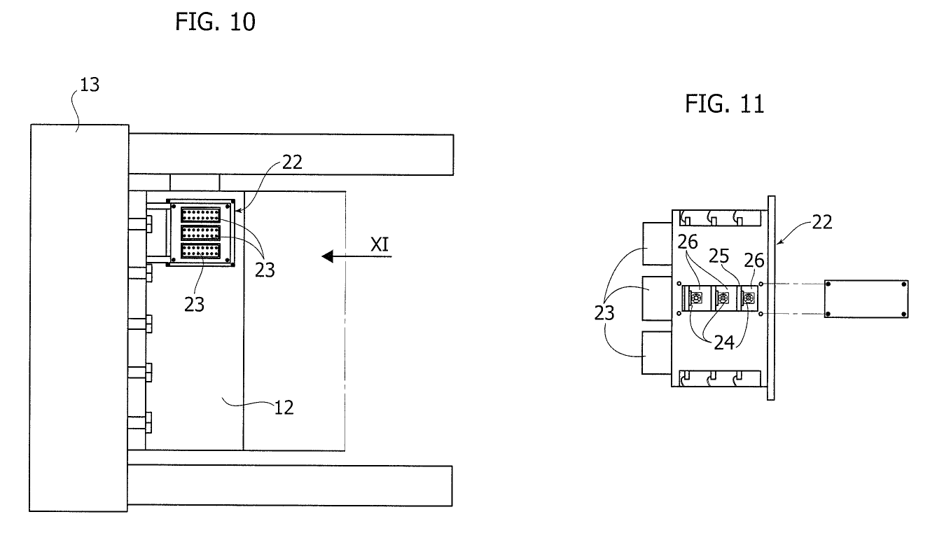

As illustrated in detail in FIGS. 10 and 11 the supply and control unit 22 is provided with injection machines with electric connection 23 for the electric mains input and electronic control boards 26 associated to the three rotary electric motors 15 for the manual configuration of the main parameters (including the position, speed, acceleration, maximum opening stroke, maximum closing force, closing torque) for closing and opening the valve pins 10 of each injector 8.

The number of the electronic control boards 26 does not necessarily coincide with the number of electric motors 15 present in the mould 4, i.e. the driver of a single electronic control board 26 may be combined with more than one electric motor 15, for example given that two or more injectors 8 require the same opening and closing parameters. In other cases, a single driver may be capable of memorising more than one configuration of the opening and closing parameters designated for more than one injector 8.

The operator may manually configure the driver of the single circuit boards 26 by means of potentiometers 24, for example attainable through a special opening 25 obtained in the supply and control unit 22, so that it does not have to be opened completely thus avoiding the risk of damaging or dirtying the components contained therein. Alternatively, the configuration of the single circuit boards 26 may be carried out by means of special push buttons or a control panel arranged on the unit 22, or it may be carried out remotely for example directly on the control panel of the injection machine.

However, according to a preferred embodiment, the configuration is carried out by the operator through a universal external control panel (for example PLC), i.e. usable for the configuration of the drivers of any supply and control unit 22 according to the invention, even fixed to different moulds.

Upon configuring the drivers of the circuit boards 26 regarding each electric motor 15, the control panel (contrary to what occurs in the prior art solutions with a stand-alone electronic unit) can be disconnected and a control for opening and closing each injector 8 can be directly sent by the control panel of the injection machine or, alternatively, by a general sequential control unit already owned by the user.

The above clearly shows the extreme simplicity of the actuation system of the injectors 8 which enables obtaining moulding apparatus which, excluding the absence of hydraulic/pneumatic connections, are substantially similar to the fluid actuation moulding apparatus, even more so given that the connections between the injection machine and mould remain intact.

The supply and control unit 22 is also externally similar to the boxes designated for supplying the solenoid valves in fluid systems and, as concerns what has been illustrated above, the input for opening and closing the valves of the injectors may be directly carried out out by the control panel of the injection moulding machine, just like in conventional pneumatic or hydraulic systems. However, with respect to the latter, there are obtained considerable advantages in terms of construction simplicity, cleaning and the possibility of intervening on the main parameters for opening and closing the injectors, and with considerable reduction of costs and overall dimensions with respect to those of the prior art electric systems. Basically, the customer gets a mould complete with a unit for supplying and controlling electric motors univocally associated thereto, without having to purchase, position and connect a stand-alone electronic control unit, often over-dimensioned with respect to the actual need.

According to an alternative embodiment, the rotary motor 15 is a direct current electric motor without an encoder or resolver. This solution enables reducing costs further when a control on the speed and/or acceleration for opening and closing the injectors 8 (not on the position) is sufficient.

For example, with reference to the configuration of the speed for opening and closing the injector, upon setting the configuration the driver directly acts on the actual operating voltage, or alternatively on voltage splitting through a PWM (pulse width modulation) system.

Costs saving is further accentuated by the elimination of the limit switch adjustment devices, necessarily present in the prior art solutions, in that the control board of the direct current motor is per se capable of recognising when the motor, or the valve pin 10 driven by it, is under stress, so as to be able to stop automatically. Such evaluation is carried out based on the absorption of the electric motor currents.

Lastly, given the absence of the encoder or resolver, the motor output only features the conductors intended for supplying power, thus adding further advantages in terms of reducing overall dimensions and facilitating installation.

Electric motors can also be used equally advantageously in cases where the latter with the relative transmissions are carried—in place of the fixing plate 12—by the machine platen 13, or by a support thereof arranged laterally with respect to the fixing plate, according to the description and illustration subject of the aforementioned patent no EP-3009251A1. In this case, the variable length transmission rods 17 will extend through the fixing plate 12.

Same applies in cases where the electric motors and the relative transmissions are directly carried by the distributor 6, as described in the aforementioned patent application no EP-2679374A1.

Lastly, the invention remains valid even in cases where electric motors 15 move respective valve pins 10 in transversal direction, or however not coaxial, with respect to the corresponding injector 8 between a closing position and an opening position, for example as described by the Italian patent application no IT-102016000044688 on behalf of the Applicant of this patent (not published as of date of filing of the present application).

According to a further characteristic of the invention, the supply and control unit 22 is removably fixed to the mould 4, in particular to enable the user to pass to an advanced system provided with a stand-alone electronic unit according to the prior art, or vice versa, at any time.

For example, every mould provided with electric motors may be manufactured provided with supply and control connectors designated for motors 15 and the stand-alone electronic unit according to the prior art. However, the user has the freedom of removably fixing the supply and control unit 22 according to the invention above and laterally with respect to the connectors.

The supply and control unit 22 may also be removed from one mould and fixed to another mould provided with electric motors 15, and then subsequently configuring, adding or removing control boards 26 depending on the number of motors 15 and required parameters.

Obviously, the construction details and embodiments may widely vary with respect to what has been described and illustrated, in particular as regards the type of motor used or the instrument used by the user to configure the driver of the circuit board or for sending the control for opening and closing each injector, without departing from the scope of protection of the present invention as defined in the claims that follow.

1. An apparatus for injection moulding of plastic materials including:
a mould comprising a distributor of the plastic material to be injected,
at least one injector including a nozzle with respect to which a valve pin is movable,
a or a respective electric actuator for controlling displacement of the valve pin between a closing and an opening position to enable flow of fluid plastic material under pressure from the distributor to a cavity of the mould, and
a supply and control unit for supplying and controlling the or the respective electric actuator,
wherein the supply and control unit is secured to the mould and is univocally associated thereto.

2. The apparatus according to claim 1, wherein the supply and control unit is provided with connectors for electric mains input.

3. The apparatus according to claim 1, wherein the supply and control unit is provided with at least one electronic control board for configuring main parameters for opening and closing each injector associated to each electric actuator.

4. The apparatus according to claim 3, wherein each electric actuator is an electric motor, and wherein for each electric motor there is associated an electronic control board with the relative driver and the configuration control being set by potentiometers operatively connected to the driver of the electronic control board of each electric motor.

5. The apparatus according to claim 3, wherein to each electric motor (15) there is associated an electronic control board with relative driver and the configuration control being set by push buttons or a control panel arranged on the supply and control unit or it is performed remotely.

6. The apparatus according to claim 3, wherein to each electric motor there is associated an electronic control board with relative driver and the configuration control being set by a universal external control panel.

7. The apparatus according to claim 3, wherein control for opening and closing each injector according to the parameters configured on the electronic control board is sent by the control panel of the injection machine or by a general sequential control unit.

8. The apparatus according to claim 1, further comprising a machine platen and a fixing plate for securing the mould to the machine platen, wherein the supply and control unit is applied to the fixing plate.

9. The apparatus according to claim 1, further comprising a structure for supporting cables fixed to the distributor of the mould, wherein the supply and control unit is applied to such structure for supporting cables.

10. The apparatus according to claim 1, wherein the respective electric actuator is a brushless electric motor.

11. The apparatus according to claim 1, wherein the respective electric actuator is a direct current electric motor.

12. The apparatus according to claim 1, wherein the respective electric actuator is an asynchronous or universal electric motor.

13. The apparatus according to any one of the claim 1, wherein the electric actuator is a rotary motor to which there is associated a nut and screw transmission unit which controls an oscillating lever for actuating the valve pin.

14. The apparatus according to claim 13, further comprising a machine platen and a fixing plate for securing the mould to the machine platen wherein the rotary motor and the relative nut and screw transmission unit are carried by the fixing plate.

15. The apparatus according to claim 14, wherein the distributor is located in a recess of the fixing plate facing towards the moulding cavity and the rotary motor with the relative screw-and-nut assembly is housed within a seat of the fixing plate facing towards the machine platen.

16. The apparatus according to claim 13, further comprising a machine platen and a fixing plate for securing the mould to the machine platen, wherein the rotary motor with the relative nut and screw transmission unit is carried by the fixing plate.

17. The apparatus according to any one of claim 13, wherein said nut and screw transmission unit actuates a variable length transmission rod extending through the fixing plate to control an oscillating lever which actuates the valve pin of the injector.

18. The apparatus according to claim 17, wherein the rotary motor, the nut and screw transmission unit and the variable length transmission rod form a pre-assembled unit.

19. The apparatus according to claim 17, wherein said oscillating lever is carried by the distributor.

20. The apparatus according to claim 1, wherein the mould comprises supply and control connectors designated for the electric actuators and a stand-alone electronic unit, and wherein the supply and control unit is removably fixed to such connectors.

21. The apparatus according to claim 1, wherein the supply and control unit is configured to be removed from one mould, fixed to another mould provided with one or more electric actuators and configured for a moulding process provided for the another mould.
